(19) United States
(12) Patent Application Publication
(10) Pub. No.: US 2026/0187099 A1
(43) Pub. Date: Jul. 2, 2026

(54) DATA GENERATION SYSTEM

(71) Applicant: SEMICONDUCTOR ENERGY LABORATORY CO., LTD., Atsugi-shi (JP)

(72) Inventors: Naoaki TSUTSUI, Atsugi (JP); Ryo NAKAZATO, Ebina (JP)

(21) Appl. No.: 19/415,047

(22) Filed: Dec. 10, 2025

(30) Foreign Application Priority Data
Dec. 27, 2024 (JP) 2024-231662

(51) Int. Cl. G06F 16/25; G06F 16/901

(52) U.S. Cl. CPC G06F 16/258; G06F 16/9024

(57) ABSTRACT

A novel data generation system is provided, which includes a first data processing device having a function of generating a netlist by converting a hardware description language into graph-structured data and performing arithmetic processing based on Monte Carlo tree search, a second data processing device having a function of converting the graph-structured data into matrix data using a graph neural network, and a third data processing device including a transformer model and generating a first command in accordance with an input token sequence. The first data processing device has a function of generating a random number, and as a command executed in the Monte Carlo tree search, the first command or a second command selected using a calculation formula of action selection is selected in accordance with a magnitude relationship between the random number and a specified value.

### BACKGROUND OF THE INVENTION

### 1. Field of the Invention

One embodiment of the present invention relates to a data generation system for performing what is called logic synthesis, which generates a netlist from a hardware description language.

### 2. Description of the Related Art

Digital circuit design has steps such as function design, logic synthesis, and automatic placement and routing. Among them, logic synthesis is a step of converting the digital circuit operation written in a hardware description language (hereinafter referred to as an HDL) into a format called a netlist. A netlist is also referred to as a gate level netlist.

A netlist is connection information on an input terminal or an output terminal of a standard cell included in the designed digital circuit. A standard cell is a circuit element used for logic synthesis or automatic placement and routing and has a function of a predetermined circuit element such as an AND gate or an OR gate.

In logic synthesis, a netlist is optimized so as to satisfy predetermined specifications such as operation speed and power consumption. In the case where the designed digital circuit cannot have predetermined specifications by the logic synthesis, it is necessary to repeat the logic synthesis or redo the process from the functional design. When the number of repetitions or redoings is increased, the design time increases and thus a digital circuit cannot be provided at low cost. Therefore, development of logic synthesis software with higher optimization performance is being considered.

In recent years, a model using an artificial neural network (ANN, hereinafter simply referred to as a neural network in some cases) has been actively developed. As an approach to the automation of the above-described logic synthesis, methods using machine learning such as a neural network (e.g., Non-Patent Document 1) or Monte Carlo Tree Search (hereinafter referred to as MCTS) (e.g., Non-Patent Document 2) have been proposed. In addition, a natural language processing method by an autoregressive model using a transformer architecture (e.g., Non-Patent Document 3) has been proposed.

### REFERENCE

[Non-Patent Document 1] A. B. Chowdhury and four others, “INVICTUS: Optimizing Boolean Logic Circuit Synthesis via Synergistic Learning and Search”, Cornell University, Internet URL: https://arxiv.org/abs/2305.13164
[Non-Patent Document 2] Zehua Pei and five others, “AlpahSyn Logic Synthesis Optimization with Efficient Monte Carlo Tree Search”, 2023, IEEE/ACM ICCAD, Internet URL: https://ieeexplore.ieee.org/document/10323856
[Non-Patent Document 3] Ashish Vaswani et al., “Attention Is All You Need”, Internet URL: https://arxiv.org/abs/1706.03762
[Non-Patent Document 4] Cunxi Yu et al., “Fast Algebraic Rewriting Based on And-Inverter Graphs”, IEEE Transactions on Computer-Aided Design of Integrated Circuits and Systems, Vol. 37, No. 9, 1907-1911 (2018)
[Non-Patent Document 5] Alan Mishchenko and two others, “DAG-Aware AIG Rewiring”, University of California, Berkeley, Internet URL: https://people.eecs.berkeley.edu/˜alanmi/publications/2006/dac06_rwr.pdf

### SUMMARY OF THE INVENTION

In automation of logic synthesis using MCTS, a calculation formula such as Upper Confidence bounds applied to Trees (UCT) is used. The use of a calculation formula that considers the balance between exploration and exploitation typified by UCT can increase the probability of obtaining an optimal solution. However, since exploration is performed without considering the state of the circuit to be optimized, efficient processing is not easily performed, and optimization performance has its limitation. In the automation of logic synthesis using MCTS, further improvement in performance is required.

In addition, in automation of logic synthesis using a neural network, it is necessary to optimize weight data by learning for generating a netlist from a hardware description language. For the optimization of the weight data, a large amount of learning data is required; thus, when learning data cannot be prepared, there is a possibility that a desired netlist cannot be obtained. In the automation of logic synthesis using a neural network, further improvement in performance is required.

An object of one embodiment of the present invention is to provide a novel data generation system or the like. An object of one embodiment of the present invention is to provide a data generation system or the like that is highly convenient. An object of one embodiment of the present invention is to provide a data generation system or the like that is highly useful.

The present invention does not necessarily need to achieve all of these objects. The description of these objects does not disturb the existence of other objects of the present invention. Other objects can be derived from the description of the specification, the drawings, and the scope of claims, for example.

One embodiment of the present invention is a data generation system for generating a netlist from a hardware description language. The data generation system includes an input device that receives the hardware description language; a first data processing device having a function of generating the netlist by converting the hardware description language into graph-structured data and performing arithmetic processing based on Monte Carlo tree search; a second data processing device having a function of converting the graph-structured data into matrix data using a graph neural network; a third data processing device including a transformer model and generating a first command in accordance with an input token sequence; and an output device outputting the netlist. The first data processing device has a function of generating a random number. As a command executed in the Monte Carlo tree search, the first command or a second command selected using a calculation formula of action selection is selected in accordance with a magnitude relationship between the random number and a specified value.

In the data generation system of one embodiment of the present invention, the token sequence is preferably a plurality of the commands selected immediately before in the action selection of the Monte Carlo tree search and a plurality of matrix data corresponding to the graph-structured data updated by the commands.

In the data generation system of one embodiment of the present invention, the transformer model preferably includes an attention head, and the commands input to the attention head and the matrix data input to the attention head are preferably supplied separately.

In the data generation system of one embodiment of the present invention, the calculation formula of the action selection is preferably Upper Confidence bounds applied to Trees (UCT).

In the data generation system of one embodiment of the present invention, the graph-structured data is preferably data converted into an and-inverter graph.

Note that other embodiments of the present invention will be described in the following embodiments with reference to the drawings.

With one embodiment of the present invention, a novel data generation system or the like can be provided. With one embodiment of the present invention, a data generation system or the like that is highly convenient can be provided. With one embodiment of the present invention, a data generation system or the like that is highly useful can be provided.

The present invention does not necessarily need to have all of these effects. The description of these effects does not disturb the existence of other effects of the present invention. Other effects can be derived from the description of the specification, the drawings, and the scope of claims, for example.

### BRIEF DESCRIPTION OF THE DRAWINGS

FIG. 1 is a block diagram illustrating a data generation system of one embodiment of the present invention.

FIG. 2 is a flow chart showing a data generation system of one embodiment of the present invention.

FIGS. 3A and 3B are schematic views for describing a data generation system of one embodiment of the present invention;

FIGS. 4A and 4B are schematic views for describing a data generation system of one embodiment of the present invention;

FIGS. 5A and 5B are schematic views for describing a data generation system of one embodiment of the present invention.

FIG. 6 is a block diagram illustrating a data generation system of one embodiment of the present invention.

FIGS. 7A and 7B are schematic views illustrating a data generation system of one embodiment of the present invention.

FIGS. 8A and 8B are schematic views illustrating a data generation system of one embodiment of the present invention.

FIG. 9 is a schematic view illustrating a data generation system of one embodiment of the present invention.

FIGS. 10A and 10B are schematic views illustrating a data generation system of one embodiment of the present invention.

FIG. 11 is a schematic view illustrating a data generation system of one embodiment of the present invention.

FIG. 12 is a schematic view illustrating a data generation system of one embodiment of the present invention.

### DETAILED DESCRIPTION OF THE INVENTION

An embodiment of the present invention will be described with reference to the drawings. Note that it is easily understood by those skilled in the art that modes of the present invention can be changed in various ways without departing from the spirit of the present invention. Therefore, the present invention should not be construed as being limited to the description in the following embodiment.

In this specification and the like, when a plurality of components are denoted by the same reference numeral, and, particularly when they need to be distinguished from each other, identification signs such as “A”, “B”, “_1”, “_2”, or “[n]” are sometimes added to the reference numeral, for example. When matters common to a plurality of components with identification signs are described or when they do not need to be distinguished from each other, no identification sign is added in some cases.

### Embodiment

In this embodiment, an example of a data generation system of one embodiment of the present invention will be described. The data generation in one embodiment of the present invention corresponds to a series of steps in which a netlist is generated from an input HDL and then output.

### <Structure Example of Data Generation System>

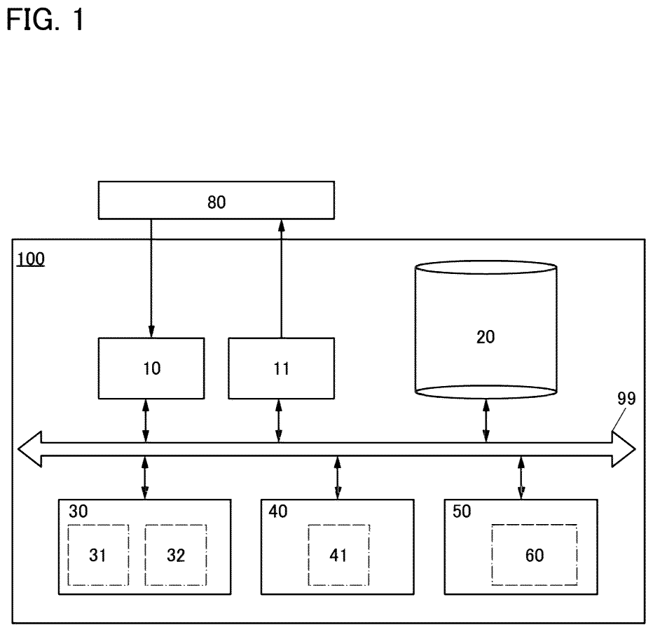

A structure example of the data generation system of one embodiment of the present invention will be described. FIG. 1 is a block diagram illustrating a data generation system of one embodiment of the present invention.

In a block diagram in this specification and the like, components are classified in accordance with function and shown by blocks independent of each other. However, in an actual device, system, or the like, it is difficult to separate components in accordance with function, and there is such a case where one device is associated with a plurality of functions or a case where a plurality of devices or systems are associated with one function. For example, a plurality of data processing devices are illustrated as separate blocks having different functions, but can be one block having different functions.

FIG. 1 illustrates a terminal device 80 and a data generation system 100. The data generation system 100 includes an input device 10, an output device 11, a memory device 20, a data processing device 30, a data processing device 40, a data processing device 50, and a transmission unit 99.

The input device 10 has a function of receiving a hardware description language (HDL) from the terminal device 80 outside the data generation system 100. In the case of the digital circuit design, the HDL is register transfer level (RTL) data such as a Verilog HDL. In the following description, the HDL is RTL.

The output device 11 has a function of outputting a netlist generated by the data generation system 100 receiving RTL to the terminal device 80 outside the data generation system 100.

The terminal device 80 is an information terminal such as a data server, a desktop computer, a laptop computer, a smartphone, or a tablet computer.

When a provider of a service using the data generation system and a user of the service belong to the same organization such as a company, for example, the data transmission and reception between the data generation system 100 and the terminal device 80 is preferably performed via a network such as a local area network (LAN) constructed within the organization. Accordingly, data transmission and reception between the data generation system 100 and the terminal device 80 can be performed more safely than when it is performed via the Internet. Furthermore, internal information can be prevented from leaking to the outside. Alternatively, data transmission and reception between the data generation system 100 and the terminal device 80 can be performed via the Internet, which is the infrastructure of the World Wide Web (WWW).

The memory device 20 can store a program and/or data, for example. Typical examples of the program include programs executed by the data processing devices 30, 40, and 50. The data stored in the memory device 20 is, for example, RTL transmitted from the input device 10. Examples of the data stored in the memory device 20 include data that is in the middle of processing in the data processing devices 30, 40, and 50.

The memory device 20 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory.

The transmission unit 99 has a function of transmitting data. Data transmission and reception between the input device 10, the output device 11, the memory device 20, and the data processing devices 30, 40, and 50 can be performed via the transmission unit 99.

The data processing devices 30, 40, and 50 have a function of performing data processing such as arithmetic operation, analysis, and inference. The memory device 20 stores data that is in the middle of processing in the data processing devices 30, 40, and 50. The data processing devices 30, 40, and 50 obtain necessary data from the memory device 20. The data processing devices 30, 40, and 50 each have a function of performing different arithmetic processing on the data in the memory device 20.

The data processing devices 30, 40, and 50 each include at least an arithmetic circuit in order to have the above functions. As the arithmetic circuit, for example, a central processing unit (CPU) can be included. The data processing devices 30, 40, and 50 can each include a graphics processing unit (GPU), a neural network processing unit (NPU), or the like in addition to or instead of the CPU.

The data processing devices 30, 40, and 50 can each include a microprocessor such as a digital signal processor (DSP) in addition to the CPU or the GPU. The DSP is specialized in digital signal processing and is thus preferably included so as to control a peripheral circuit and the like of the CPU, the GPU, or the NPU. The microprocessor can be configured with a programmable logic device (PLD), which is operated by hardware, such as a field programmable gate array (FPGA) or a field programmable analog array (FPAA).

Next, the data processing devices 30, 40, and 50 each having a function of performing different arithmetic processing are described.

The data processing device 30 includes a processing selection unit 31 and an MCTS arithmetic unit 32. The processing selection unit 31 has a function of converting the RTL before processing into graph-structured data and a function of generating a random number. The MCTS arithmetic unit 32 has a function of generating a netlist by performing arithmetic processing based on Monte Carlo Tree Search (MCTS). The data processing device 30 is also referred to as a first data processing device.

The graph-structured data is a data format obtained by converting circuit diagram data included in text data written in RTL into labeled data on a node, a terminal, or the like. By converting the circuit diagram data into the graph-structured data, optimization processing can be facilitated.

As the graph-structured data, an and-inverter graph, which is a kind of a directed acyclic graph, can be used (see Non-Patent Document 4, for example). With this structure, the RTL in which specifications of digital circuit design are written can be converted into graph-structured data in the form of Boolean function; thus, data processing can be performed efficiently.

As one method for balancing exploration and exploitation in action selection of MCTS, the calculation formula of Upper Confidence bounds applied to Trees (UCT) can be used. UCT can be represented by Formula (1). The first term, which is W, represents exploitation and is reward or the average of reward. As the reward, an area, a delay value, or the like of a circuit represented by a netlist can be used. The second term represents exploration, c is a constant, m is the number of trials, and N is the cumulative number of trial times.

$$\begin{matrix}[ Formula 1 ] & \\ UCT = W + c \sqrt{\frac{ln N}{m}} & ( 1 )\end{matrix}$$

UCT is useful for determining selection of a promising command to be given next on the basis of the results of expansion and trial of MCTS. Examples of the command include balance in which optimization is performed to reduce delay using the commutative law or the associative law, and rewrite in which optimization is performed by converting into a partly equivalent circuit using pattern matching (see Non-Patent Document 5, for example). Note that a command is also referred to as command data.

In generation of a netlist using MCTS, the optimal netlist can be explored for by repeating the processing by which the original state is brought into the next state through four steps of action selection, expansion, trial, and update. The action selection of the command corresponds to the step of selecting the next node (child node) of MCTS, and selecting an appropriate command from command candidates is important for generating a desired netlist.

The processing selection unit 31 generates a random number before the action selection step. In accordance with the magnitude relationship between the random number and a specified value, the processing selection unit 31 selects, as the action selection step of MCTS, either a command (also referred to as a first command) generated using a transformer model (also simply referred to as a transformer) or a command (also referred to as a second command) selected using the calculation formula of the action selection. The selected command is a command for the action selection step of MCTS. The transformer is an architecture also referred to as an autoregressive model.

The MCTS arithmetic unit 32 performs arithmetic processing of expansion, trial, and update, which are the other steps of MCTS than the action selection step, by the command (the first command or the second command) selected in the processing selection unit 31. Accordingly, the MCTS arithmetic unit 32 performs arithmetic processing of expansion, trial, and update by the command selected using the calculation formula of the action selection (the second command), or by the command generated using the transformer.

The data processing device 40 includes a GNN arithmetic unit 41. The GNN arithmetic unit 41 has a function of performing an arithmetic operation using a graph neural network (GNN). The data processing device 40 includes the GNN arithmetic unit 41, so that graph-structured data is converted into matrix data represented by an adjacency matrix and a feature matrix to be processed using a graph neural network, whereby features of the graph-structured data can be extracted as a matrix. The data processing device 40 is also referred to as a second data processing device.

The data processing device 50 includes a transformer 60. The transformer 60 includes a plurality of decoder layers DEC. The transformer 60 has a function of generating a new token sequence in accordance with an input token sequence. The data processing device 50 includes the transformer 60 and thus can generate a token sequence in accordance with the input token sequence.

As the input token sequence, a command in the MCTS arithmetic unit 32 in the data processing device 30, which is selected immediately before in action selection, and the matrix data in the GNN arithmetic unit 41 in the data processing device 40, which is updated by the command selected immediately before in the action selection, are supplied. With this structure, candidates for the command to be selected next in the action selection can be generated as a token sequence to be generated. The MCTS arithmetic unit 32 performs arithmetic processing of expansion, trial, and update by the command (the first command) selected from the command candidates generated in the data processing device 50. The data processing device 50 is also referred to as a third data processing device.

The transformer 60 can be made to learn the graph-structured data of the circuit diagram data in the past design and its corresponding command as teacher data. For example, the transformer 60 is made to learn, as teacher data, graph-structured data by which the known command selected in the digital circuit designed in the past is labeled with. A command to be selected in the case where the graph-structured data of the circuit diagram data is unknown can be generated.

### <Example of Data Generation Flow Chart of Data Generation System>

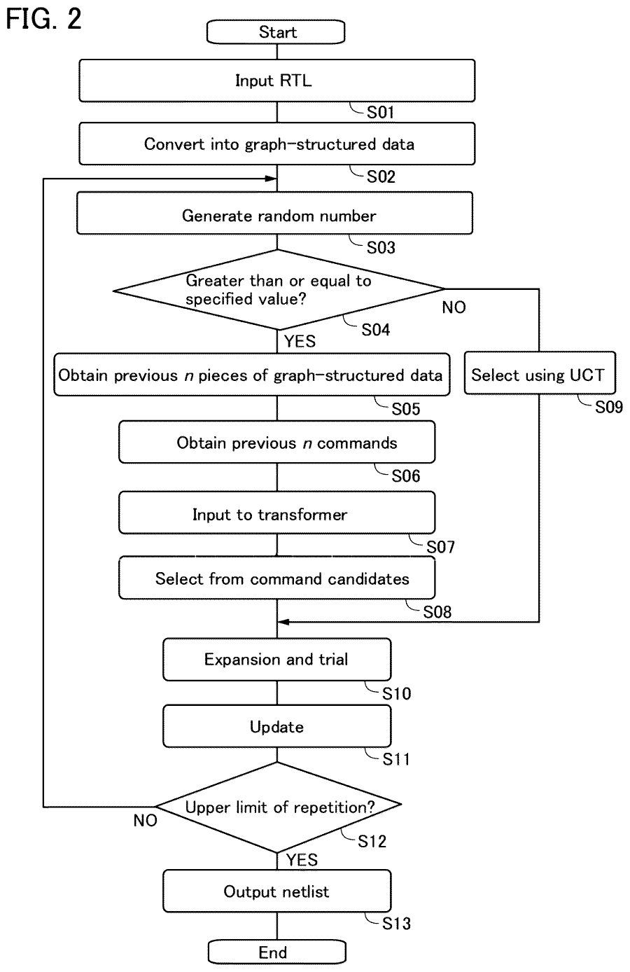

FIG. 2 is a flow chart showing an operation of the data generation system 100. The data generation system 100 can generate a netlist from RTL through Steps S01 to S13.

In Step S01, RTL is input. To the data generation system 100, the RTL is input from the terminal device 80 through the input device 10.

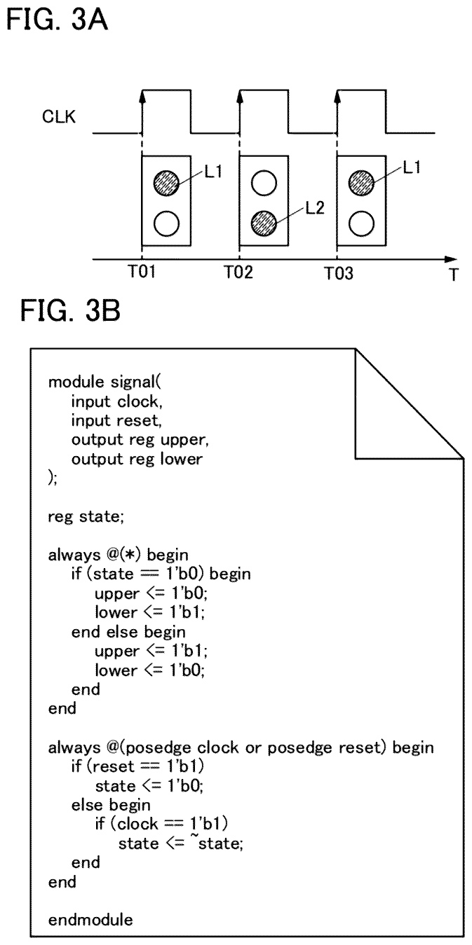

For example, in functional design of a digital circuit, a controller by which two lamps are alternately turned on at regular intervals is designed. FIG. 3A is a schematic view of the functional design and illustrates an example in which the lighting of an upper lamp L1 and a lower lamp L2 is switched at Times T01 to T03 in accordance with a clock signal CLK. In this case, the RTL can be written in text as shown in FIG. 3B. The text shown in FIG. 3B is an example of information for executing the function design illustrated in FIG. 3A.

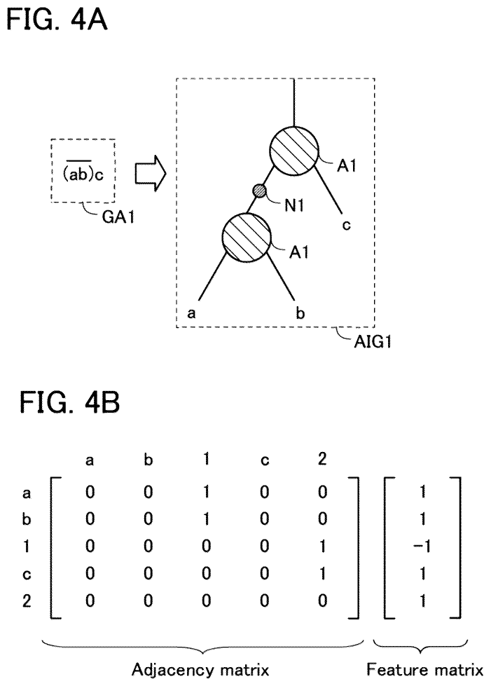

In Step S02, the RTL is converted into graph-structured data. Since the RTL is text data, the RTL is preferably converted into a data format that is easily subjected to arithmetic processing. As described above, an example of the graph-structured data is an and-inverter graph. As illustrated as an example in FIG. 4A, in the case of a logical conjunction (AND) of a negation of a logical conjunction (NAND) of a and b and c (data GA1), the and-inverter graph can be represented as data AIG1 in which AND nodes A1, an edge N1 representing negation, and terminals of a to c are connected. In the data generation system 100, conversion from RTL to AIG can be performed in the processing selection unit 31.

In Step S03, a random number is generated. For example, a random real number in the range of 0 to 1 is generated in the data processing device 30. The random number is updated again after the steps of action selection, expansion, trial, and update.

In Step S04, whether or not the random number is greater than or equal to a specified value is determined. Steps after Step S04 are selected in accordance with the magnitude relationship between the random number generated in Step S03 and the specified value. Specifically, in the case where the random number is greater than or equal to the specified value (YES), the action selection step of MCTS is determined by a command generated in the transformer (Steps S05 to S08). In the case where the random number is less than the specified value (NO), a command for the action selection step of MCTS is selected using the calculation formula of UCT (Step S09).

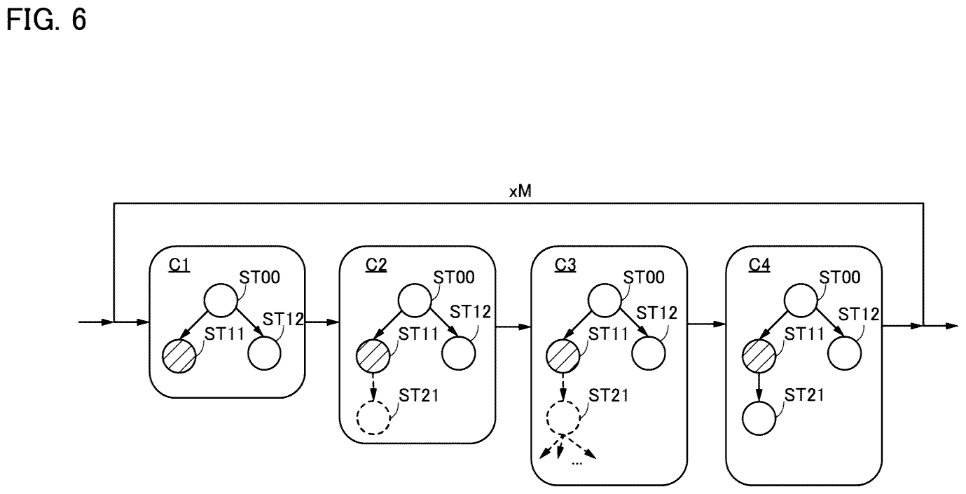

Here, the four steps of action selection, expansion, trial, and update of MCTS are illustrated in FIG. 6.

In MCTS, four steps C1 to C4 are repeated (e.g., M (M is an integer) times), whereby the next state of the graph-structured data can be optimized.

Step C1 is action selection. In Step C1 in FIG. 6, a node ST00 corresponds to the initial state, and nodes ST11 (hatched) and ST12 each correspond to the next state; the node ST11 or the node ST12 is selected in the action selection from the node ST00. The node ST00 is also referred to as a parent node, and the nodes ST11 and ST12 are each also referred to as a child node.

Step C2 is a step of generating a new child node ST21 when the number of selection times of the selected node in Step C1 exceeds a predetermined number. The newly generated child node is referred to as an expanded node.

In Step C3, a trial in accordance with the node selected in Step C1 or the expanded node in Step C2 is performed. In the case where the node ST21 is generated in Step C2, a trial from the next node ST21 (a leaf node) is performed by a command. The trial of the node ST21 can be performed by a randomly selected command or the like.

In Step C4, the trial in Step C3, a reward value, and the like are updated. The update step of Step C4 is also referred to as backpropagation. A node with a higher score based on the reward value is more likely to be selected in the action selection.

The above is the description of the four steps of action selection, expansion, trial, and update of MCTS.

The description of FIG. 2 is now resumed. In Step S05, previous n (n is an integer) pieces of graph-structured data are obtained. The previous n pieces of graph-structured data correspond to the graph-structured data updated by executing the steps of MCTS by the command selected in the action selection. The previous n pieces of graph-structured data can be stored in the memory device 20 and obtained by being read from the memory device 20.

The graph-structured data is converted into matrix data by processing an adjacency matrix and a feature matrix in the GNN arithmetic unit 41, and the matrix data is input to the transformer. As an example of matrix data, FIG. 4B shows an example of an adjacency matrix and a feature matrix of graph-structured data. FIG. 4B is the adjacency matrix and the feature matrix corresponding to the data AIG1 represented by the and-inverter graph in FIG. 4A.

In Step S06, previous n commands are obtained. The previous n (n is an integer) commands correspond to the commands selected in the action selection steps of MCTS. The previous n commands can be stored in the memory device 20 and obtained by being read from the memory device 20.

In Step S07, a token sequence is input to the transformer. To the transformer, matrix data corresponding to the previous n pieces of graph-structured data in Step S05 and the previous n commands in Step S06 are supplied as the token sequence.

In Step S08, a command is selected from its candidates. The transformer generates candidates for a command to be selected in the next action selection, specifically probabilities of a plurality of commands, in accordance with the input token sequence. An appropriate command can be selected from the plurality of candidates for the command.

Step S10 is expansion and trial. In accordance with the action selection by the command generated in the transformer in Step S08 or the action selection by the command selected using the calculation formula of UCT in Step S09, the steps of expansion and trial of MCTS can be executed.

Step S11 is update. The reward value of each node can be updated on the basis of the steps of expansion and trial of MCTS in Step S10.

In Step S12, whether or not the number of trials is above the upper limit is determined. The number of trials to determine whether or not the graph-structured data obtained through the steps of MCTS can be output as a netlist is set in advance, and the steps of MCTS are repeated (NO) until the number of trials reaches the upper limit.

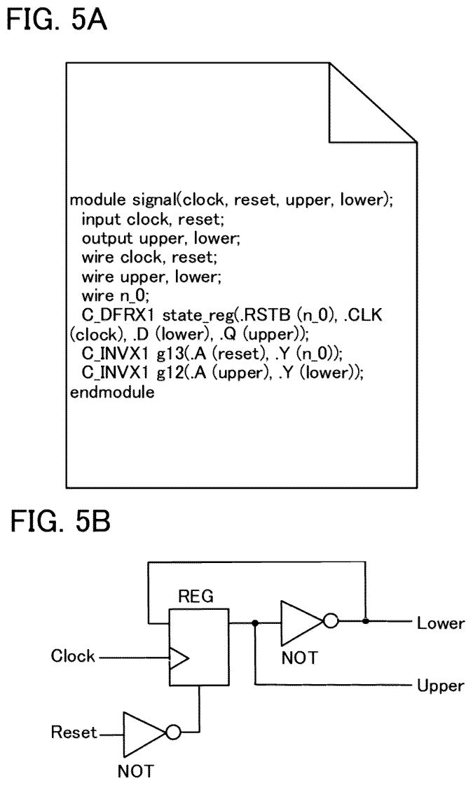

A netlist is written in text as shown in FIG. 5A. The text shown in FIG. 5A is connection information on an input terminal or an output terminal of a standard cell included in a designed digital circuit. Thus, a digital circuit can be represented with circuit elements of a NOT gate (NOT) illustrated in FIG. 5B or an AND gate (AND). The circuit in FIG. 5B can function as a controller by which two lamps are alternately turned on at regular intervals with outputs to an upper terminal (Upper) and a lower terminal (Lower) by controlling a register (REG) with a clock signal (Clock) and a reset signal (Reset).

In Step S12, when the number of trials reaches the upper limit (YES), the graph-structured data obtained by repeating the steps of MCTS is converted into a netlist and then output (Step S13).

As described above, in the structure of one embodiment of the present invention, it is possible to switch between selecting a command using the calculation formula of UCT and selecting a command using the transformer in the action selection step of MCTS in accordance with the magnitude relationship between the generated random number and the specified value. Thus, the action selection can be performed flexibly without depending only on the automation of logic synthesis using MCTS in which the action selection is performed using the calculation formula of UCT. In addition, even when sufficient learning is not reflected in the command selection using the transformer, the logic synthesis can be automated. Therefore, for example, an improvement in performance, and reductions in power consumption, chip area, design cost, and design time of a digital circuit can be achieved. As a result, a data generation system that is highly convenient and useful can be provided.

### <Example of Exploration for Action Selection Using Transformer>

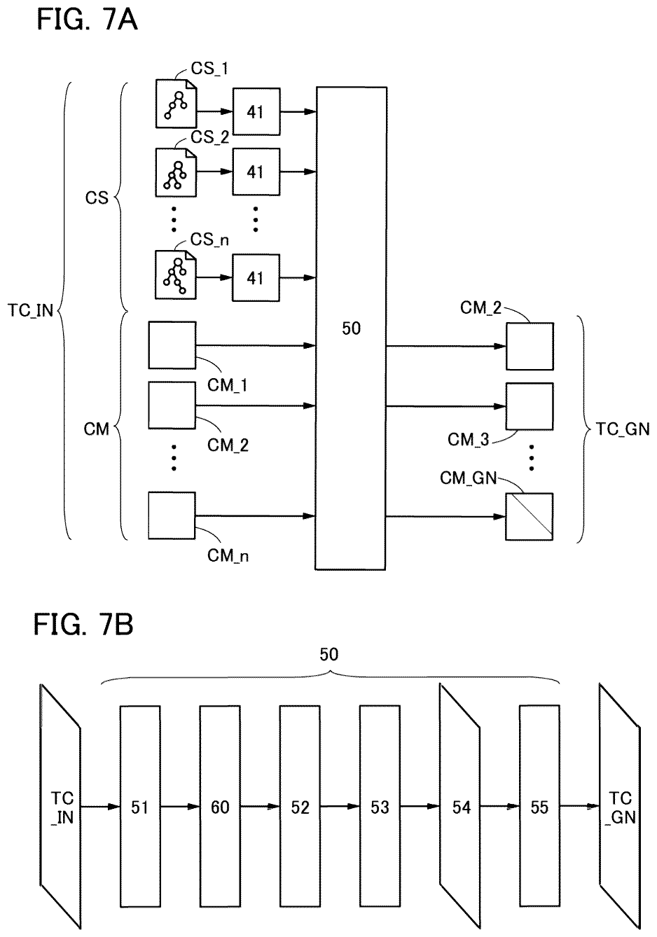

Next, an example of exploration for the action selection, that is, a method for generating a command, using the transformer is described. FIG. 7A is a schematic view illustrating the token sequence input to the data processing device 50 and the token sequence generated in the data processing device 50, which are described above.

FIG. 7A illustrates, as a token sequence TC_IN input to the data processing device 50, n commands CM (commands CM_1 to CM_n) selected immediately before and graph-structured data CS (graph-structured data CS_1 to CS_n) updated by the commands selected immediately before. The graph-structured data CS are converted into matrix data in the GNN arithmetic unit 41 in the data processing device 40, and the matrix data are input to the data processing device 50.

FIG. 7A illustrates, as the token sequence TC_GN generated in the data processing device 50, the commands CM_2 to CM_n and a newly generated command CM_GN.

FIG. 7B is a block diagram illustrating a structure example of the data processing device 50 illustrated in FIG. 7A.

As illustrated in FIG. 7B, the token sequence TC_IN illustrated in FIG. 7A is input to the data processing device 50. The token sequence TC_IN is converted into matrix data of one-hot representation in a one-hot 51. Then, after processing by the transformer 60, the token sequence TC_GN can be output through a linear layer 52, Softmax 53, a token probability 54, and token selection 55.

One-hot representation is vector representation in which, among K-dimensional vectors (K is a natural number), only the value of the dimension assigned to a token is 1, and values of all other dimensions are 0. The linear layer is processing also referred to as linear transformation or full connection. The Softmax is processing by which input data is output as a probability of a token. Input of a token probability and token selection are processing in which a token sequence obtained by selecting from token probabilities is converted with a tokenizer, whereby a token sequence including a generated command is generated.

The transformer 60 can provide a data column with probabilities of the next data following the data column. Thus, by inputting the n commands CM selected immediately before and the graph-structured data CS updated by the commands selected immediately before as a token sequence to the data processing device 50, probabilities of commands following the n commands CM selected immediately before can be provided, and a command can be generated in accordance with the probabilities.

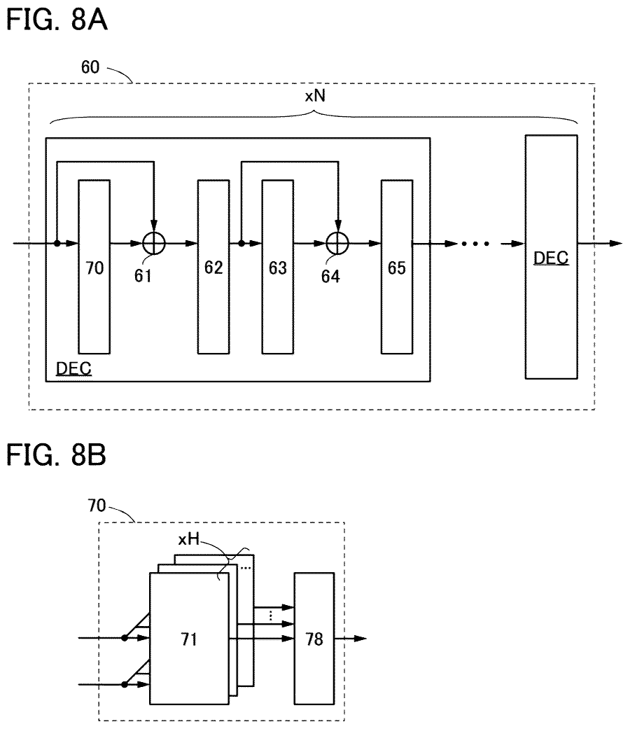

FIG. 8A is a block diagram illustrating a structure example of the transformer 60. In the transformer 60, N decoder layers DEC (N is an integer greater than or equal to 2) are provided (arranged in series) as illustrated in FIG. 8A. The plurality of decoder layers DEC each include an attention head 70, addition processing 61, layer normalization 62, a linear layer 63, addition processing 64, and layer normalization 65. Note that data input to the attention head may be subjected to addition processing of embeddings, positional data, or the like. Note that the layer normalization refers to processing of converting values such that the mean is 0 and a variance is 1 in each command.

FIG. 8B is a block diagram illustrating a structure example of the attention head 70 included in the decoder layer DEC. In the attention head 70, as illustrated in FIG. 8B, H processing layers 71 are provided in parallel and the output of each of the processing layers 71 is performed through a linear layer 78.

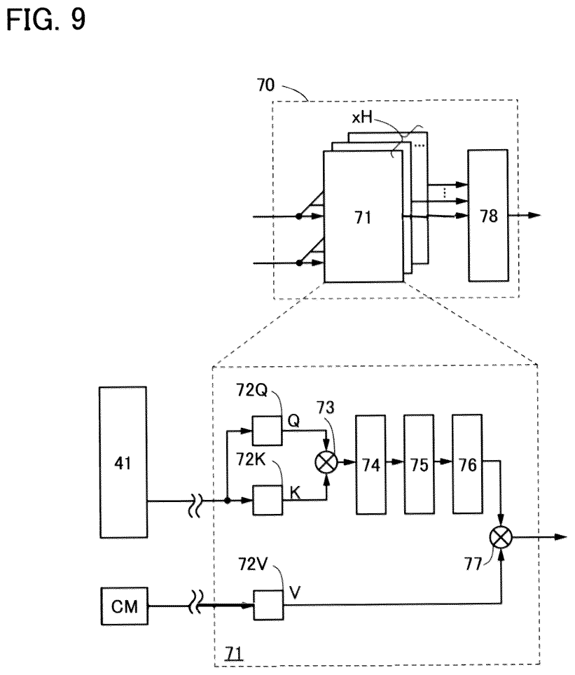

FIG. 9 is a block diagram illustrating a structure of the processing layer 71 included in the attention head 70. Note that as the processing layer 71 included in the attention head 70, a processing method that can be employed for one embodiment of the present invention is illustrated as an example. The processing layer 71 illustrated in FIG. 9 includes three input nodes Q, K, and V. The processing layer 71 includes a linear layer 72Q, a linear layer 72K, a linear layer 72V, multiplication processing 73, scaling 74, mask 75, Softmax 76, and multiplication processing 77.

The linear layers 72Q, 72K, and 72V each have a product of different matrices. With this structure, the input node Q and the input node K can have different data. In the multiplication processing 73, the input node Q and the transposed matrix of the input node K are multiplied. The scaling 74 divides each element of a matrix. In the scaling 74, a divisor k is determined by a dimension of embedded representation, the parallel number, embedded representation, and the like. The mask 75 multiplies the obtained matrix by a negative value having a large absolute value. The Softmax 76 performs conversion of the values of a matrix such that the sum of the values is 1. In the multiplication processing 77, the output of the Softmax 76 and the transposed matrix of the input node V are multiplied. Data output from each of the processing layers 71 is output through the linear layer 78.

In the example of the processing layer 71 illustrated in FIG. 9, the graph-structured data CS selected by the command selected immediately before, that is, matrix data output from the GNN arithmetic unit 41 included in the data processing device 40, is supplied to the input node Q through the linear layer 72Q. Similarly, the matrix data output from the GNN arithmetic unit 41 is supplied to the input node K through the linear layer 72K. The n commands CM selected immediately before are supplied to the input node V through the linear layer 72V. Thus, the data including information on the n commands CM and the matrix data corresponding to the graph-structured data CS updated by the command selected immediately before can be supplied separately.

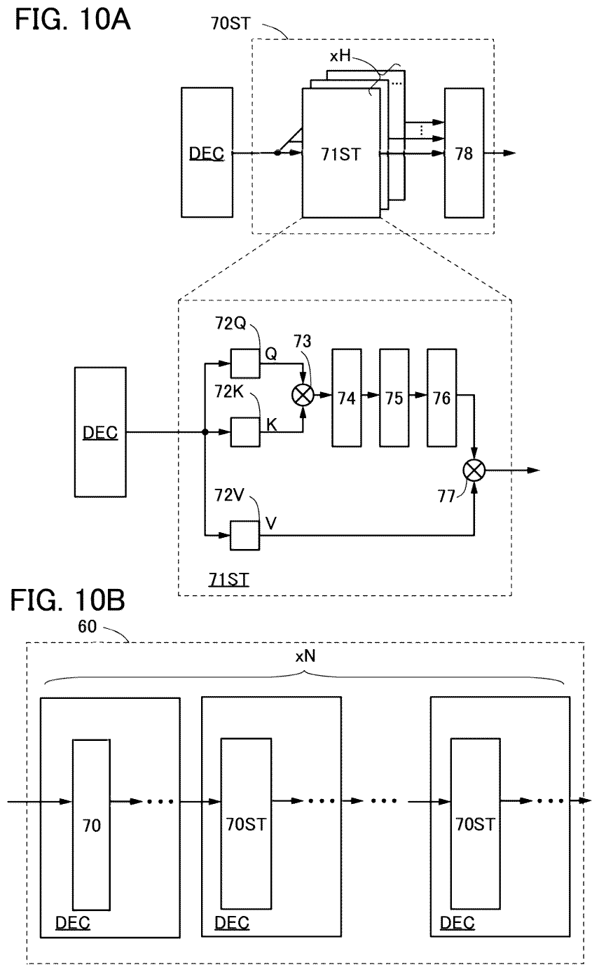

FIG. 10A is a block diagram illustrating an attention head 70ST including a processing layer 71ST to which matrix data output from the previous decoder layer DEC is supplied by a standard processing method.

The processing layer 71ST illustrated in FIG. 10A includes three input nodes Q, K, and V like the processing layer 71. In the processing layer 71ST illustrated in FIG. 10A, matrix data from the decoder layer DEC in the preceding stage is input to the input nodes Q, K, and V. Note that the input nodes Q, K, and V each have different data because different processing is performed in each of the linear layers 72Q, 72K, and 72V.

The structure in which the data supplied to the input nodes Q and K and the data supplied to the input node V are supplied separately, which is illustrated in FIG. 9, has less arithmetic processing performed on the data including information on the command CM than the structure in which the data supplied to the input nodes Q, K, and V are identical as illustrated in FIG. 10A. Thus, the data output from the processing layer 71 in the structure illustrated in FIG. 9 can more easily reflect data including information on the graph-structured data processed via the GNN arithmetic unit 41 than the data output from the processing layer 71ST in the structure illustrated in FIG. 10A.

In the transformer 60, the N decoder layers are provided (arranged in series) as described above. The decoder layer including the attention head 70ST including the processing layer 71ST and the decoder layer including the attention head 70 including the processing layer 71 can coexist. FIG. 10B illustrates a structure in which the decoder layer DEC including the attention head 70ST and the decoder layer DEC including the attention head 70 are included.

By multilayering the decoder layer DEC including the attention head 70 and the decoder layer DEC including the attention head 70ST as illustrated in FIG. 10B, data including the information on the command CM can be easily generated.

In the structure of one embodiment of the present invention, it is possible to switch between selecting a command using UCT and selecting a command using the transformer in the step of selecting a command in MCTS in accordance with the magnitude relationship between the generated random number and the specified value. Thus, the action selection can be performed flexibly without depending only on automation of logic synthesis using MCTS in which the action selection is performed using the calculation formula of UCT or the like. In addition, even when sufficient learning is not reflected in the command selection using the transformer, the logic synthesis can be automated. Therefore, for example, an improvement in the performance, and reductions in power consumption, chip area, design cost, and design time of a digital circuit can be achieved.

### <Example of Information Processing Device Including Data Generation System>

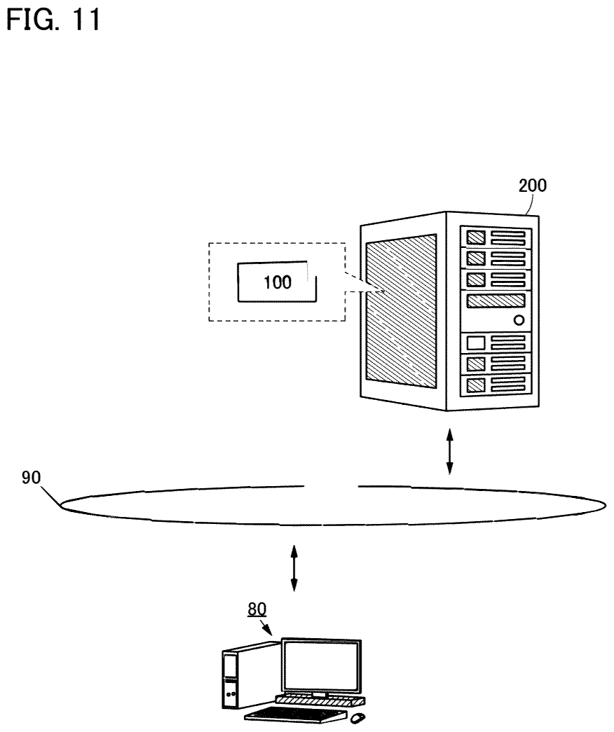

FIG. 11 is a schematic view illustrating an example of a data generation system of one embodiment of the present invention. The data generation system of one embodiment of the present invention can be used in one or more information processing devices (also referred to as computers in some cases). In other words, one embodiment of the present invention is an information processing device in which the data generation system of one embodiment of the present invention can be used.

FIG. 11 illustrates an information processing device 200, a terminal device 80, and a network 90.

The information processing device 200 can execute the data generation system 100 of one embodiment of the present invention, for example. That is, the information processing device 200 includes the components of the data generation system 100 of one embodiment of the present invention illustrated in FIG. 1, for example. The information processing device 200 and the terminal device 80 are connected to the network 90.

As the information processing device 200, a large computer such as a workstation, a server computer, or a supercomputer can be used. The information processing device 200 preferably has a function of a parallel computer. Thus, large-scale computation necessary for processing such as AI learning and inference can be performed.

As the terminal device 80, a desktop computer can be used, for example. The terminal device 80 can also be referred to as a client computer or the like.

As the network 90, a local network or a global network can be used, for example. For another example, an intranet or an extranet can be used. Other examples include a personal area network (PAN), a local area network (LAN), a campus area network (CAN), a metropolitan area network (MAN), a wide area network (WAN), and a global area network (GAN). For another example, the Internet, which is an infrastructure of the World Wide Web (WWW), can be used.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark), for example.

Here, a provider of a service using the data generation system of one embodiment of the present invention can provide the service via the network 90, for example.

Note that when a provider of a service using the data generation system of one embodiment of the present invention and a user of the service belong to the same organization (e.g., a company), a local network such as an intranet constructed within the organization is preferably used as the network 90, for example. Accordingly, data transmission and reception can be performed more safely than in the case of using a global network such as the Internet. In addition, confidential data in the organization can be prevented from leaking to the outside.

Here, a user (e.g., a designer of a semiconductor device) can access the data generation system of one embodiment of the present invention through, for example, dedicated application software or a web browser that can be operated by the terminal device 80. In this way, the user can receive the service using the data generation system.

The data generation system of one embodiment of the present invention is not limited to the structure example illustrated in FIG. 11.

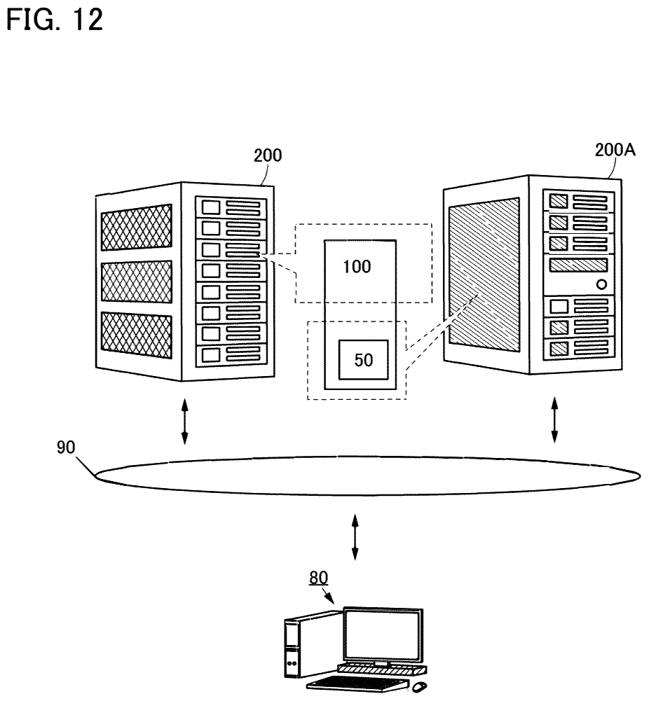

FIG. 12 is a schematic view illustrating a modification example of the data generation system illustrated in FIG. 11. The data generation system illustrated in FIG. 12 is different from that in FIG. 11 in being used in a data processing device 200A in addition to the information processing device 200 and the terminal device 80.

The data generation system 100 illustrated in FIG. 12 is used in the information processing devices 200 and 200A. Specifically, the information processing device 200A includes the data processing device 50 including a transformer, and the information processing device 200 includes all components in the data generation system 100 of one embodiment of the present invention illustrated in FIG. 1 except for the data processing device 50. Thus, the information processing devices 200 and 200A can exchange information via the network 90.

As the information processing device 200A, a large computer such as a workstation, a server computer, or a supercomputer can be used, for example. The information processing device 200A preferably has a function of a parallel computer. Thus, large-scale computation necessary for processing such as AI learning and inference can be performed, for example.

When the information processing devices 200 and 200A are connected through the network 90 in this manner, a load due to processing for data generation can be distributed. Therefore, the introduction cost and the operation cost of the data generation system can be reduced.

The data generation system of one embodiment of the present invention is not limited to the above structure example, and can have a variety of structures.

Note that one embodiment of the present invention is not limited to the data generation system or the information processing device described in this embodiment. At least some of the data generation system, the information processing device, the drawings corresponding thereto, and the like described in this embodiment as an example can be combined as appropriate.

This application is based on Japanese Patent Application Serial No. 2024-231662 filed with Japan Patent Office on Dec. 27, 2024, the entire contents of which are hereby incorporated by reference.

What is claimed is:

1. A data generation system for generating a netlist from a hardware description language, the data generation system comprising:
an input device configured to receive the hardware description language;
a first data processing device configured to generate the netlist by converting the hardware description language into graph-structured data and performing arithmetic processing based on Monte Carlo tree search;
a second data processing device configured to convert the graph-structured data into matrix data using a graph neural network;
a third data processing device comprising a transformer model and configured to generate a first command in accordance with a token sequence; and
an output device configured to output the netlist,
wherein the first data processing device is configured to generate a random number, and
wherein in the Monte Carlo tree search, the first data processing device is configured to execute the first command or a second command selected using a calculation formula of action selection in accordance with a magnitude relationship between the random number and a specified value.

2. The data generation system according to claim 1,
wherein the token sequence is a plurality of the commands selected immediately before input of the token sequence to the third data processing device in the action selection of the Monte Carlo tree search and a plurality of the matrix data updated by the plurality of the commands.

3. The data generation system according to claim 2,
wherein the transformer model comprises an attention head, and
wherein input of the commands to the attention head and input of the matrix data to the attention head are supplied separately.

4. The data generation system according to claim 1,
wherein the calculation formula of the action selection is Upper Confidence bounds applied to Trees (UCT).

5. The data generation system according to claim 1,
wherein the graph-structured data is an and-inverter graph.
